(19) United States
(12) Patent Application Publication
(10) Pub. No.: US 2025/0251119 A1
(43) Pub. Date: Aug. 7, 2025

(54) Flashing signal system with adaptive duty cycle

(71) Applicant: Lights To Go Inc., Rose Hill, KS (US)

(72) Inventor: William Andreas, Derby, KS (US)

(21) Appl. No.: 18/831,445

(22) Filed: Jan. 24, 2025

Related U.S. Application Data
(60) Provisional application No. 63/624,605, filed on Jan. 24, 2024.

(51) Int. Cl. F21V 23/04; F21S 9/03; F21W 111/02; H02J 7/00; H02J 7/35

(52) U.S. Cl. CPC F21V 23/0407; F21S 9/035; H02J 7/0063; H02J 7/35; F21W 2111/02

(57) ABSTRACT

The disclosure presents a signal system that dynamically adjusts the light system duty cycle in response to battery charge levels. The system can be used for solar-powered flashing signs to extend the operational life of the sign during periods of insufficient solar charging. The system incorporates lamps controlled by a microcontroller that monitors battery voltage and adjusts the duty cycle while maintaining flash frequency. The controller implements stepwise duty cycle reduction when battery voltage falls below specified thresholds, substantially extending battery life without sacrificing visibility of the signal system.

### CROSS-REFERENCE TO RELATED APPLICATION

This application claims priority to U.S. Provisional Patent Application No. 63/624,605, which is hereby incorporated by reference in its entirety.

### FIELD

This disclosure generally pertains to a flashing signal system.

### BACKGROUND

Solar-powered alternating (“wig-wag”) flashing signals are commonly used in school zones, pedestrian crossings, and traffic warning applications. These renewable energy-powered systems have increased in popularity because of their lower installation and operational costs, as well as the growing demand for sustainable solutions. While solar power offers advantages in installation simplicity and operational reliability, these systems have drawbacks.

During periods without direct sunlight, these signals must operate on battery power alone. For typical solar-powered signs to maintain battery charge indefinitely, they must be exposed to sunlight for an average of three to six hours per day. Extended periods of adverse weather conditions, such as sustained cloud cover or snow accumulation, can deplete the battery to a level that is insufficient for continued operation of the signal. In such instances, conventional signal systems may cease functioning entirely, creating potential safety hazards. The vulnerability of solar-powered signs to adverse environment factors needs to be addressed with a more resilient approach, particularly for critical safety applications where continuous operation is essential.

### SUMMARY

Disclosed herein is a flashing signal system with an adaptive duty cycle. The signal system comprises a light system including at least one lamp configured to flash according to a programmable duty cycle, a battery system including at least one battery to provide power to the light system, and a controller connected to the battery system and the light system, wherein the controller determines a charge level of the battery and adjusts the duty cycle of the light system in response to a change of the charge level of the battery. In an embodiment, the signal system includes a solar array connected to the battery system for charging the battery system. The controller can store at least one threshold value representing a battery system charge level that is below the full charge level. The controller adjusts the flash duty cycle of the light system when the controller determines that the battery charge level has crossed one of the threshold values in ascending or descending order.

One aspect of the disclosed system incorporates a controller including a microcontroller connected to an analog-to-digital converter. The microcontroller stores at least one threshold value. The threshold value is a battery voltage level below a full charge level of the battery. The controller measures the battery voltage level through the analog-to-digital converter, compares the measured battery voltage level to the at least one threshold value stored in the microcontroller, and adjusts a flash duty cycle of a light system based on the battery voltage level crossing the at least one threshold value in ascending or descending order.

In an aspect, a signal system comprises a light system including at least one lamp configured to flash according to a programmable duty cycle. A battery system includes at least one battery. The battery system provides power to the light system. A controller is connected to the battery system and the light system. The controller determines a charge level of the battery and adjusts the duty cycle of the light system in response to a change of the charge level of the battery.

In another aspect, a controller for a signal system comprises a microcontroller connected to an analog-to-digital converter. The microcontroller stores at least one threshold value. The at least one threshold value is a battery voltage level below a full charge level of the battery. The controller measures the battery voltage level through the analog-to-digital converter, compares the measured battery voltage level to the at least one threshold value stored in the microcontroller, and adjusts a flash duty cycle of a light system based on the battery voltage level crossing the at least one threshold value in ascending or descending order.

In another aspect, a signal system comprises a light system including at least one lamp configured to flash according to a programmable duty cycle. A battery system includes at least one battery. The battery system provides power to the light system. A controller is connected to the battery system and the light system. The controller includes an analog-to-digital converter. The controller stores at least one threshold value. The at least one threshold value is a battery voltage level below a full charge level of the battery. The controller measures the battery voltage level through the analog-to-digital converter, compares the measured battery voltage level to the at least one threshold value stored in the microcontroller, and adjusts a flash duty cycle of the light system based on the battery voltage level crossing the at least one threshold value in ascending or descending order.

Other aspects will be in part apparent and in part pointed out hereinafter.

### BRIEF DESCRIPTION OF THE DRAWINGS

FIG. 1 is a schematic illustration of a signal system according to the present disclosure.

FIG. 2A is a perspective view of a signal system in an operating environment;

FIG. 2B is a perspective view of a signal system in an operating environment;

FIG. 2C is an elevation view of a signal system with a light system incorporated into the sign;

FIG. 3A is a diagram of a 50% duty cycle for a signal system with two lamps;

FIG. 3B is a diagram of a 25% duty cycle for a signal system with two lamps;

FIG. 3C is a diagram of a 10% duty cycle for a signal system with two lamps;

FIG. 4 is graph showing the threshold values for a lithium-ion battery system of a signal system according to an exemplary embodiment of the present disclosure;

FIG. 5 is a schematic of a signal system with controller components according to an exemplary embodiment of the present disclosure;

FIG. 6 is a schematic of duty cycle switching at threshold values with hysteresis regions; and

FIG. 7 is a schematic of a signal system according to an embodiment of the present disclosure.

Corresponding parts are given corresponding reference characters throughout the drawings.

### DETAILED DESCRIPTION

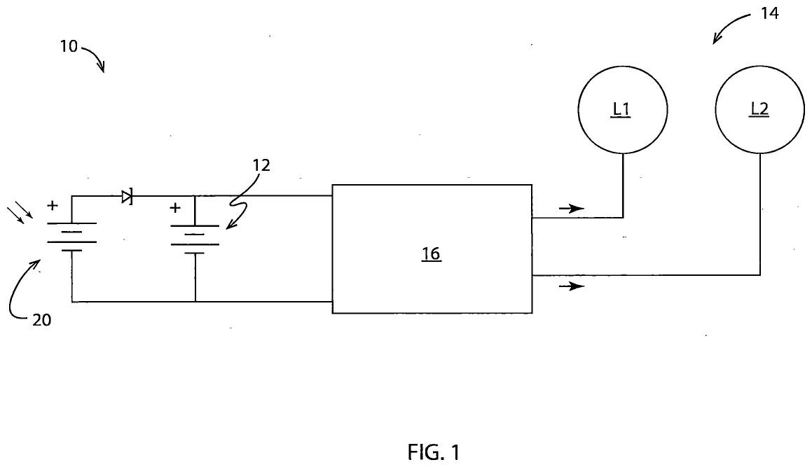

Referring now to FIG. 1, an exemplary embodiment of a signal system in accordance with the present disclosure is generally indicated at reference number 10. In FIG. 1, the signal system is shown schematically to represent various types of flashing signals. The signal system 10 incorporates a light system 14 with at least one lamp, typically an LED lamp. FIG. 1 shows a first lamp L1 and a second lamp L2 connected to a controller 16. The controller 16 is connected to the battery system 12. The battery system 12 has at least one battery to provide power to the light system 14 through the controller 16. In an embodiment, the battery system 12 may be connected to a solar array 20, which charges the battery system with solar energy. This disclosure is not limited to a particular type of signal system but can encompass any type of signal system with battery-powered flashing light systems.

The signal system 10 is broadly configured to change the duty cycle of the light system 14 in response to a change in the charge level of the battery system 12. The controller 16 determines the charge level of the battery system 18 and adjusts the duty cycle of the light system 14 in response to a change in the charge level of the battery. As will be explained in further detail below, the duty cycle of the light system corresponds to the percentage of time the light is on during a flash cycle.

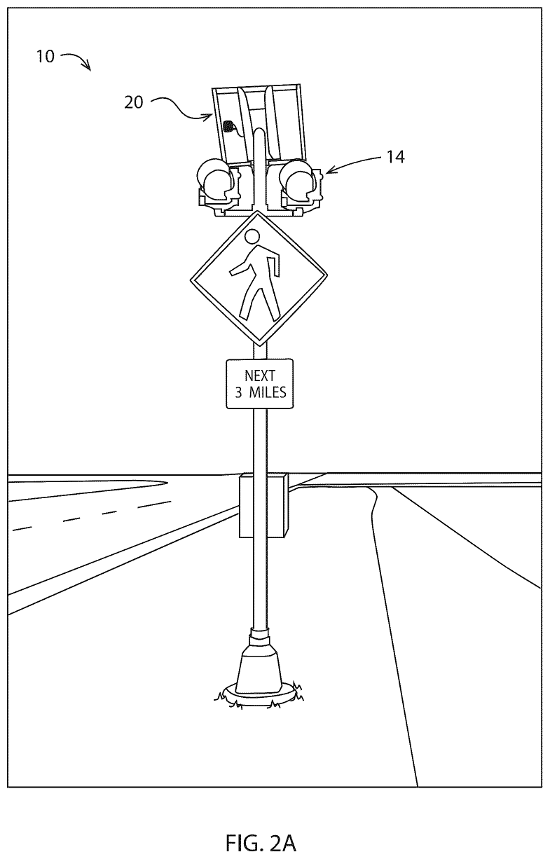

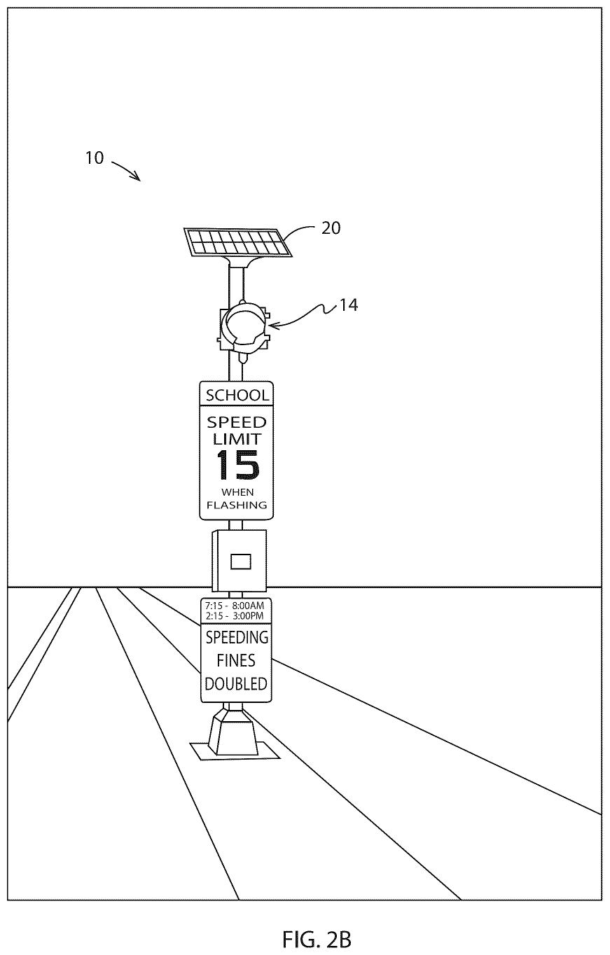

Turning now to FIGS. 2A-2C, the signal system 10 of the present disclosure may be applied to various types of signs with flashing lights. Non-limiting examples of these signs are shown in FIGS. 2A-C and include pedestrian crossing signs (FIG. 2A), school zone signs (FIG. 2B), reduced speed limit signs (not shown), school bus stop signs (not shown), flashing stop signs (FIG. 2C), and flashing warning signs (not shown), such as “DO NOT ENTER” or “WRONG WAY” signs. In general, these types of signs may employ solar arrays to provide power to the flashing lights. Flashing lights may be incorporated into the sign or may be external to the sign as shown in FIGS. 2A and 2B. The signal system of the present disclosure can operate for an extended period without sunlight by automatically adjusting the system duty cycle when the charge state of the battery drops below one or more predetermined values. Furthermore, the duty cycle may be automatically selected based on the battery charge state, ambient light level, time of day, temperature, and/or other factors.

During optimal conditions with direct sunlight and a fully charged battery, the light system operates at a normal duty cycle, such as a 50% duty cycle. When solar input diminishes, the battery becomes the sole power source for the lighting system, causing the battery voltage to decline. After approximately 36-60 hours of insufficient solar power input, the battery voltage drops significantly. The signal system monitors the changes in battery voltage and adjusts (e.g., reduces) the flash duty cycle in response to the changes in order to preserve battery power and increase the time that the signal system can provide effective visual flashing.

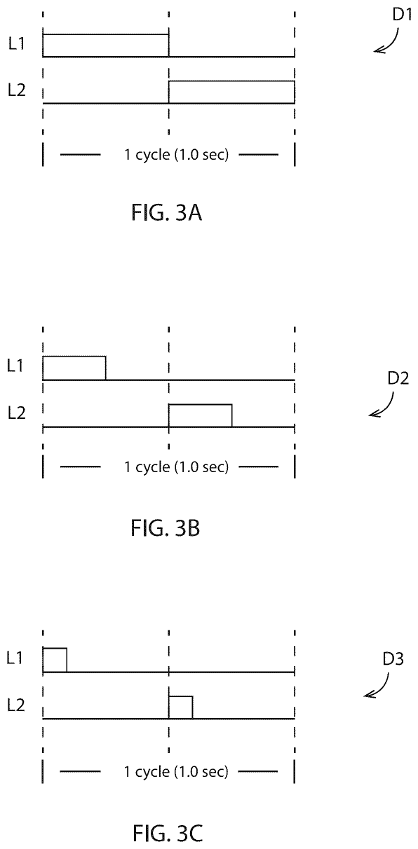

FIGS. 3A-3C shows three examples of different duty cycles of the light system. As mentioned previously, the duty cycle is the percentage of a flash cycle that a given light is on. For example, a lamp that is cycled on for 0.5 seconds and then off for 0.5 seconds during each one-second period of time is operating at a duty cycle of 50%. A lamp operating in accordance with a flashing schedule having a lower duty cycle, (e.g., 25%) will consume less energy than a lamp operating with a higher duty cycle (e.g., 50%).

In FIGS. 3A-3C, an exemplary duty cycle chart is shown for an alternating light system, that is, two lamps, LI and L2 that are flashing in an alternating pattern. In the 50% duty cycle D1, during a 1 second flash cycle, lamp L1 is turned on at the start of the flash cycle for 50% (0.5 seconds) of the flash cycle. Then the first lamp L1 is turned off and the second lamp L2 is turned on for the next 50% (0.5 seconds) of the flash cycle or 0.5 seconds. Each individual lamp, thus, has a 50% duty cycle.

FIG. 3B depicts an example of a reduced power alternating flash cycle in which each lamp L1, L2 is operated at only a 25% duty cycle. In the 25% duty cycle D2, each lamp L1, L2 is on for 25% of the flash cycle. Lamp L1 is turned on at the start of the cycle and kept on for the first 25% of the cycle (0.25 seconds), during which the lamp L2 remains off. Then lamp L1 is turned off and both lamps remain off for the next 25% of the cycle. Then lamp L2 is turned on for the next 25% of the cycle, while the lamp L1 remains off. Finally, lamp L2 is turned off and both lamps remain off for the final 25% of the cycle. Accordingly, during the illustrated reduced power alternating flash cycle D2, there are two intervals of time (cumulatively 50% of the cycle) during which neither lamp is on, which reduces power consumption in relation to the normal duty cycle D1. The reduction in duty cycle from 50% to 25% may reduce the power consumption rate of the light system by about 50% as compared with the 50% duty cycle flashing pattern depicted in FIG. 3A.

FIG. 3C depicts an example of a further reduced power alternating flash cycle in which each lamp L1, L2 is operated at only a 10% duty cycle. In the 10% duty cycle D3, each lamp L1 is on for 10% of the flash cycle. Lamp L1 is turned on at the start of the cycle and kept on for the first 10% of the cycle (0.1 seconds), during which the lamp L2 remains off. Then lamp L1 is turned off and both lamps remain off for the next 40% (0.4 seconds) of the cycle. Then lamp L2 is turned on for the next 10% of the cycle, while the lamp L1 remains off. Finally, lamp L2 is turned off and both lamps remain off for the final 40% of the cycle. During the further reduced power alternating flash cycle D3, there are two intervals of time (cumulatively 80% of the cycle) during which neither lamp L1, L2 is on, which reduces power consumption in relation to the normal duty cycle D1 and the first reduced power cycle D2. The reduction in duty cycle from 50% to 10% may reduce the power consumption rate of the light system by about 80% as compared with the normal 50% duty cycle flashing pattern depicted in FIG. 3A.

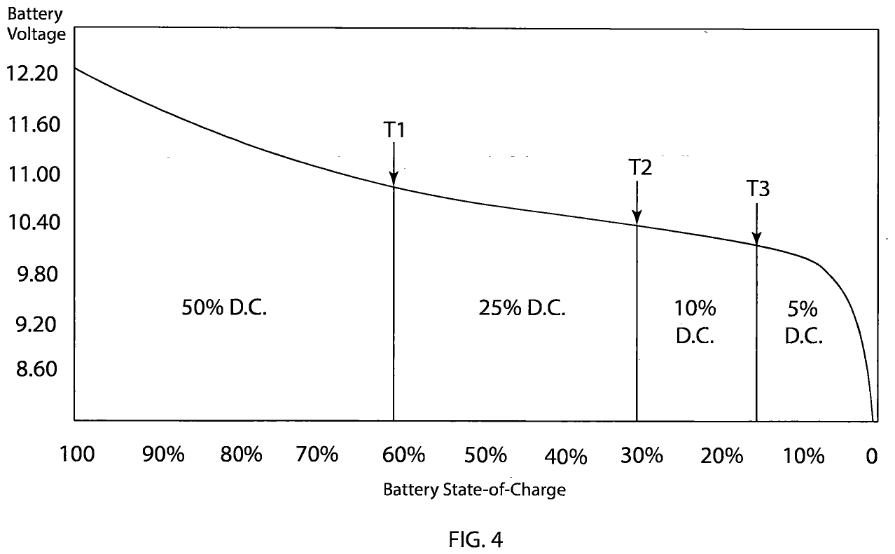

According to an aspect of the present disclosure, the controller stores pre-programmed threshold values that trigger duty cycle adjustments. These threshold values correspond to specific battery charge states below full capacity. In FIG. 4, the threshold points for a lithium-ion battery system are shown at points along a battery discharge curve. The battery state of charge is shown on the x-axis and the battery voltage is shown on the y-axis of the graph. The light system 14 is programmed to operate a 50% duty cycle during normal operating conditions and when the battery is at a full level of charge. When the battery charge level crosses the first threshold value T1, the controller 16 automatically reduces the duty cycle.

In an example, the flash duty cycle is reduced to a level that is in an inclusive range of from 40% to 60% of the normal duty cycle when the charge level of the battery (or, more broadly, a parameter (e.g., a measured parameter) indicative of a charge level of the battery) falls to a first threshold value T1 indicative of a charge level in an inclusive range of from 50% to 70% of the full charge level of the battery. In the specific, non-limiting embodiment depicted in FIG. 4, the first threshold value T1 is programmed at a 60% battery state-of-charge. And when the battery charge level reaches the first threshold value T1, the duty cycle is reduced to 25%.

In an example, the flash duty cycle is reduced to a level that is in an inclusive range of from 15% to 30% of the normal duty cycle when the charge level of the battery (or, more broadly, a parameter (e.g., a measured parameter) indicative of a charge level of the battery) falls to a second threshold value T2 indicative of a charge level in an inclusive range of from 20% to 40% of the full charge level of the battery. In the specific non-limiting example in FIG. 4, second threshold value T2 is programmed at 30% battery state-of-charge, at which the duty cycle is reduced to 10%.

In an example, the flash duty cycle is reduced to a level that is in an inclusive range of from 1% to 15% of the normal duty cycle when the charge level of the battery (or, more broadly, a parameter (e.g., a measured parameter) indicative of a charge level of the battery) falls to a first threshold value T3 indicative of a charge level in an inclusive range of from 1% to 20% of the full charge level of the battery. In the specific, non-limiting embodiment depicted in FIG. 4, the third threshold value T3 is programmed at a 15% battery state-of-charge, at which the duty cycle of the light system is reduced to a 5% duty cycle.

Three threshold values are shown in the non-limiting example of FIG. 4, but more or fewer threshold values may be programmed depending upon factors such as the operating conditions of the signal system 10.

In an example, the duration of each flash cycle rate remains constant at 1 second across all duty cycle changes. When the duty cycle decreases to 5%, each lamp illuminates for 5% of the cycle period, producing brief, strobe-like flash that serves as a visual indicator of low battery voltage for maintenance crews. Inconsistent weather conditions may cause the system to signal the need for system service or battery pack replacement. When the duty cycle is reduced to 5%, which translates to a 90% theoretical power savings, the operational life of the remaining battery is extended significantly which prevents a complete failure of the signal.

The battery system 12 can utilize either lead acid/AGM or lithium-ion batteries. The duty cycle changeover threshold values vary based on battery configuration, chemistry type, and discharge voltage curves. The voltage-to-charge state relationship for lead acid batteries is well-established and understood by those skilled in the art. Lithium-ion battery exhibit a flatter discharge voltage curve and require different threshold values. In either case, state-of-charge can be determined by sensing the voltage of the battery. Lithium-ion batteries may include a solar charge management circuit that protects against overcharging by disconnecting the solar array 20 once the battery 18 reaches full charge. Similarly, the circuit prevents permanent damage from undercharging by disconnecting a fully discharging battery from the load. The signal system of the present disclosure extends the life cycle of the battery system by reducing power draw when the charge level of the battery is low.

The threshold values/duty cycle changeover points can be selected by the customer and tailored to a particular signal system with a particular battery system. Furthermore, the threshold values can be tailored for specific operating conditions such as higher threshold values for areas that receive less sunlight on a regular basis. In an embodiment, the signal system includes sensors such as temperature, humidity, and light sensors to automatically compensate for environmental conditions that would affect battery performance.

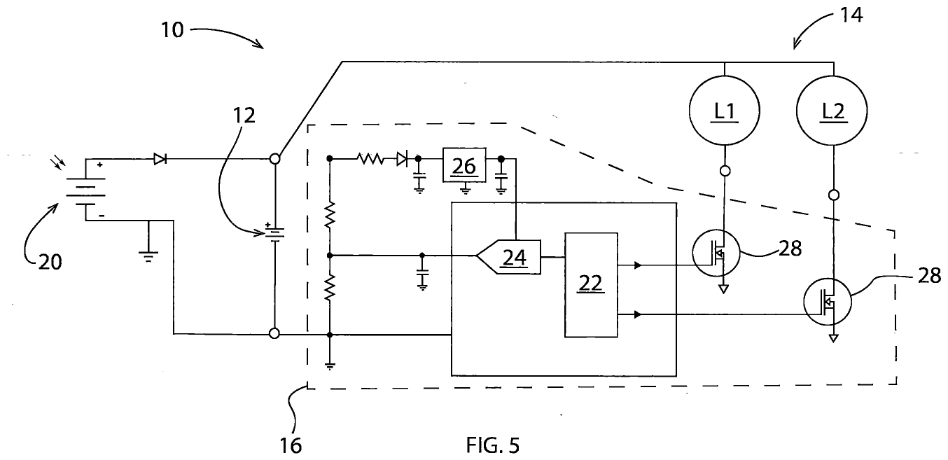

Turning to FIG. 5, an exemplary signal system is illustrated in a schematic. The controller 16 includes a microcontroller 22 connected to an analog-to-digital converter 24. The microcontroller 22 is configured to store at least one threshold value, which represents a battery voltage charge level that is below the battery's full charge level. In an example, the microcontroller may be an 8-bit Microchip PIC12F752 microcontroller.

The controller 16 monitors the battery voltage through the analog-to-digital converter 24, which can perform continuous measurements. The controller 16 compares the measured battery voltage level to the threshold values stored in the microcontroller 22 and adjusts the light system's flash duty cycle when the battery voltage crosses a threshold.

Battery voltage measurements through the analog-to-digital converter 24 take place at predetermined intervals. The voltage is sampled and converted by the analog-to-digital converter 24 to a digital value. During reduced duty cycle operation, the sampling occurs during the intervals between flashes to avoid voltage measurement errors that may occur during the “on” time of the lamp. In a specific, non-limiting example, the program converts the battery voltage to an integer value once per second, compares this value to the threshold values in a lookup table, and branches to the corresponding duty cycle control loop. The duty cycle adjustments occur when the threshold values are crossed in either ascending or descending order as the battery charge level changes, as will be discussed in further detail below.

The controller 16 may also contain a voltage regulator 26 connected to the analog-to-digital converter 24 to provide a reference voltage to the converter and the microcontroller. In an embodiment, the voltage regulator is a HT7550 micropower, low drop out, CMOS regulator with 1% accuracy, contributing to the flasher's minimal power consumption of approximately <24 μW. A transistor 28 electrically connected to the microcontroller 22 and the light system 14 controls power delivery to the light system. In an example, the microcontroller 22 provides the slew rate limited drive for the N Channel MOSFETs, which serve as the switching elements for controlling the output loads.

Although FIG. 5 presents a schematic for an alternating flashing signal system, single flashing applications such as “STOP” signs as shown in FIG. 2C could use a similar control system. The light system 14 on a single lamp flashing signal can be driven by a single channel of the controller 16 without efficiency loss. The unused output channel draws minimal additional current. Apart from using only one output of the controller 16, all other operational details remain the same to control a single flashing sign.

In an embodiment, the controller 16 includes a pulse width modified (PWM) high-frequency pulse train to control the intensity of the lamps. An integrated light sensor monitors ambient light conditions, and when ambient light diminishes, the PWM dimming reduces the light system's brightness, decreasing nighttime power consumption when maximum lamp brightness isn't required. This optimization extends battery life by reducing power usage during low-light conditions. For environmental protection, the controller 16 may be housed in a sealed enclosure.

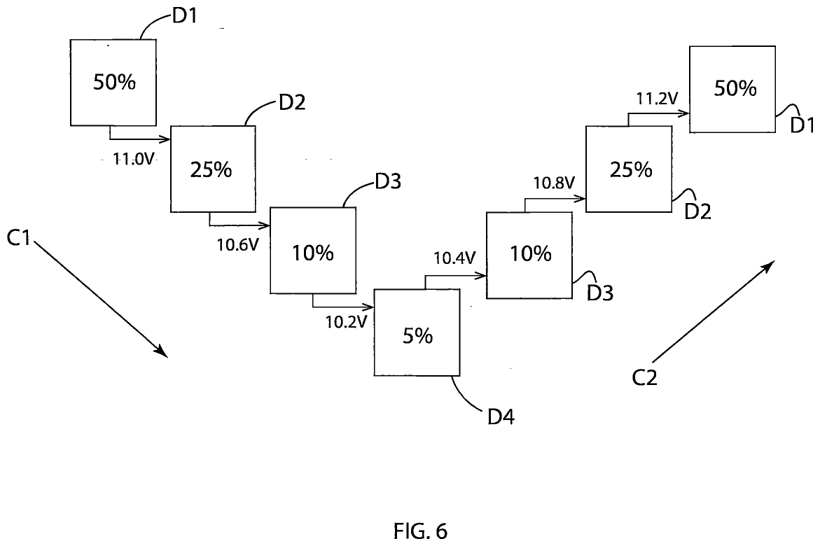

Referring next to FIG. 6, the controller 16 can suitably be programmed to incorporate a hysteresis region corresponding to each threshold value stored within the controller. The threshold value for duty cycle adjustment varies within a specified range, depending on whether the battery level is descending (discharging) C1 or ascending (charging) C2. In this example, the duty cycle reduces from 50% to 25% when battery voltage falls to 11.0V in descending order C1. The duty cycle increases from 25% to 50% when voltage rises to 11.2V in an ascending order C2. The hysteresis region for each threshold value prevents oscillation between duty cycles D1-D4, which is particularly important during the initial duty cycle change from normal (e.g., 50%) to reduced (e.g., 25%) when the sudden load reduction causes rapid voltage recovery. The hysteresis region accounts for this positive feedback and prevents the device from dithering between duty cycle levels.

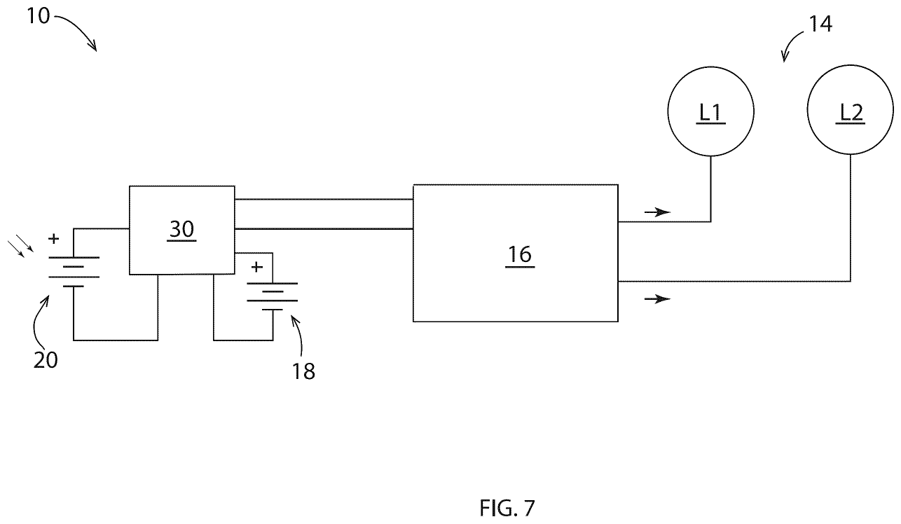

In another embodiment, the signal system includes a solar charge controller 30 as shown in FIG. 7. The solar charge controller 30 protects the battery from overcharging and disconnects the light system completely if the voltage falls below a critical level. For AGM/lead acid batteries, this separate controller prevents overcharging by disconnecting the solar array 20 from the battery system 12 once full charge is reached. The solar charge controller 30 operates in conjunction with the controller 16 for the light system 14.

It can now be seen that the present disclosure provides a signal system that flashes with an adaptive duty cycle depending upon the state-of-charge of the battery system. The signal system preserves the critical function of providing flashing signals while extending the life of the batteries by using intelligent controls.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense. For example, while this written description focuses on digital implementation utilizing a microcontroller to select from among several discrete pre-programmed duty cycles, an alternative analog circuit may also achieve these same functions.

What is claimed is:

1. A signal system, the signal system comprising;
a light system including at least one lamp configured to flash according to a programmable duty cycle;
a battery system including at least one battery, the battery system providing power to the light system; and
a controller connected to the battery system and the light system, wherein the controller determines a charge level of the battery and adjusts the duty cycle of the light system in response to a change of the charge level of the battery.

2. The system of claim 1, further comprising a solar array, the solar array connected to the battery system for charging the battery system with solar energy.

3. The system of claim 1, wherein the light system includes at least two lamps configured to flash in an alternating pattern.

4. The system of claim 1, wherein the controller includes an analog-to-digital converter, wherein the analog-to-digital converter is configured to measure the charge level of the battery.

5. The system of claim 1, wherein the controller stores at least one threshold value, the at least one threshold value being a battery charge level below a full charge level of the battery.

6. The system of claim 5, wherein the controller adjusts the flash duty cycle of the light system when the controller determines that the battery charge level has crossed the at least one threshold value in ascending or descending order.

7. The system of claim 6, wherein the controller stores at least three threshold values with three respective flash duty cycles that are below a normal duty cycle of the light system operating with a battery having a full charge level.

8. The system of claim 7, wherein the controller adjusts the flash duty cycle to a first level in an inclusive range of from 40% to 60% of the normal duty cycle when a parameter indicative of the charge level of the battery falls to a predetermined threshold indicating a charge level in an inclusive range of from 50% to 70% of the full charge level of the battery.

9. The system of claim 8, wherein the controller adjusts the flash duty cycle to a second level that is in an inclusive range of from 15% to 30% of the normal duty cycle when a parameter indicative of the charge level of the battery falls to another predetermined threshold indicating a charge level in an inclusive range of from 20% to 40% of the full charge level of the battery.

10. The system of claim 9, wherein the controller adjusts the flash duty cycle to a third level that is in an inclusive range of from 1% to 15% of the normal duty cycle when a parameter indicative of the charge level of the battery falls to another predetermined threshold indicating a charge level in an inclusive range of from 1% to 20% of the full charge level of the battery.

11. The system of claim 1, wherein the battery is one of a lead acid battery or a lithium-ion battery.

12. The system of claim 1, wherein the signal system is one of a pedestrian crossing sign, a school zone sign, a reduced speed limit sign, a school bus stop sign, a flashing stop sign, or a flashing warning sign.

13. A controller for a signal system, the controller comprising;
a microcontroller connected to an analog-to-digital converter, the microcontroller storing at least one threshold value, the at least one threshold value being a battery voltage level below a full charge level of the battery; and
wherein the controller:
measures the battery voltage level through the analog-to-digital converter;
compares the measured battery voltage level to the at least one threshold value stored in the microcontroller; and
adjusts a flash duty cycle of a light system based on the battery voltage level crossing the at least one threshold value in ascending or descending order.

14. The controller of claim 13, further comprising a voltage regulator connected to the analog-to-digital converter to provide a reference voltage to the analog-to-digital converter.

15. The controller of claim 13, further comprising a transistor electrically coupled to the microcontroller and the light system, said transistor configured to control power delivery to the light system.

16. The controller of claim 13, wherein the measurement of the battery voltage level through the analog-to-digital converter takes place at a predetermined interval.

17. The controller of claim 13, wherein the microcontroller is programmed with a hysteresis region around the at least one threshold value to prevent oscillation during the adjustment of the flash duty cycle.

18. The controller of claim 13, wherein the microcontroller stores at least three threshold values with three respective flash duty cycles that are below a normal duty cycle of the light system operating with a battery having a full charge level.

19. The controller of claim 18, wherein the controller is configured to adjust the flash duty cycle to a first level that is between 40-60% of the normal flash duty cycle when the charge level of the battery is between 50-70% of the full charge level of the battery.

20. A signal system, the signal system comprising;
a light system including at least one lamp configured to flash according to a programmable duty cycle;
a battery system including at least one battery, the battery system providing power to the light system;
a controller connected to the battery system and the light system, the controller including an analog-to-digital converter, said controller storing at least one threshold value, the at least one threshold value being a battery voltage level below a full charge level of the battery; and
wherein the controller:
measures the battery voltage level through the analog-to-digital converter;
compares the measured battery voltage level to the at least one threshold value stored in the microcontroller; and
adjusts a flash duty cycle of the light system based on the battery voltage level crossing the at least one threshold value in ascending or descending order.
